(19) United States
(12) Patent Application Publication
(10) Pub. No.: US 2025/0267429 A1
(43) Pub. Date: Aug. 21, 2025

(54) SYSTEMS AND METHODS FOR GLOBAL NAVIGATION SATELLITE SYSTEM (GNSS) RELATED INFORMATION INDICATION

(71) Applicant: ZTE CORPORATION, Shenzhen (CN)

(72) Inventors: Fangyu CUI, Shenzhen (CN); Nan ZHANG, Shenzhen (CN); Yachao YIN, Shenzhen (CN); Junli LI, Shenzhen (CN)

(73) Assignee: ZTE CORPORATION, Shenzhen (CN)

(21) Appl. No.: 19/197,206

(22) Filed: May 2, 2025

Related U.S. Application Data
(63) Continuation of application No. PCT/CN2023/086860, filed on Apr. 7, 2023.

(51) Int. Cl. H04W 4/029; G01S 19/01

(52) U.S. Cl. CPC H04W 4/029; G01S 19/01

(57) ABSTRACT

Presented are systems and methods for global navigation satellite system (GNSS) related information indication. A wireless communication device may send a message in response to successful performance of global navigation satellite system (GNSS) positioning to a wireless communication node according to a configuration. The configuration can be from the wireless communication node, and can be a configuration for sending one or more messages indicative of successful performance of GNSS positioning.

### CROSS-REFERENCE TO RELATED APPLICATION

This application claims the benefit of priority under 35 U.S.C. § 120 as a continuation of PCT Patent Application No. PCT/CN2023/086860, filed on Apr. 7, 2023, the disclosure of which is incorporated herein by reference in its entirety.

### TECHNICAL FIELD

The disclosure relates generally to wireless communications, including but not limited to systems and methods for global navigation satellite system (GNSS) related information indication.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium of the following. A wireless communication device (e.g., a UE) may send a message in response to successful performance of global navigation satellite system (GNSS) positioning to a wireless communication node (e.g., a BS) according to a configuration (e.g., time window, timer length, resource(s), restriction). The configuration can be from the wireless communication node, and can be a configuration for sending one or more messages indicative of successful performance of GNSS positioning. The configuration may comprise information on at least one of: a specific time window; a timer; or one or more resources. The configuration can be done via RRC signaling or selected resource by MAC CE or indicated by scheduling via DCI. The resource is used to carrying the message.

In some embodiments, the resource may comprise at least one of: a preamble index; a random access channel (RACH) occasion (RO) configuration; a physical uplink control channel (PUCCH) resource; a physical uplink shared channel (PUSCH) resource corresponding to a configured grant transmission; or an uplink (UL) resource located at or after an end of a GNSS measurement time window. The UE may send the preamble with dedicated index (or mask) or over dedicated RO. In some examples, the preamble it-self may be treated as the message. The UE may send a scheduling request (SR). In some examples, the SR it-self may be treated as the message. In some examples, after the reception of SR, the gNB may schedule the following PUSCH transmission for UE to report information, e.g., validity duration. The PUSCH resource may refer to the resource for configured-grant based PUSCH transmission. The configuration of this resource can be from RRC. In some examples, the periodicity of the PUSCH resource for configured grant can be determined based on at least one of the validity duration of GNSS, length of measurement gap for GNSS acquisition and window for report the message. The UL resource can be some specific restrictions on the resource configuration in time domain. In some examples, the TA for UL transmission can be taken in to account in the configuration of UL resource in time domain.

In some embodiments, the specific time window may start from or after an end of a GNSS measurement time window (e.g., a gap). A length of the specific time window can be indicated in the configuration. The wireless communication node may determine that the wireless communication device has failed to successfully perform the GNSS positioning, if the wireless communication node has not received the message by end of the specific time window. When the specific time window starts after an end of a GNSS measurement time window, at least one of: a start time of the specific time window is indicated in the configuration; or the start of the specific time window is after a time offset with respect to the end of the GNSS measurement time window, wherein the time offset is indicated in the configuration or is predefined.

In some embodiments, the timer may start from or after an end of a GNSS measurement time window. A length of the timer's duration can be configured by network. The wireless communication node may determine that the wireless communication device has failed to successfully perform the GNSS positioning, if the wireless communication node has not received the message by expiration of the timer. When the timer starts after an end of a GNSS measurement time window, at least one of: a start time of the timer is indicated in the configuration; or the start of the timer is after a time offset with respect to the end of the GNSS measurement time window, wherein the time offset is indicated in the configuration or is predefined.

In some embodiments, the one or more resources can be configured to be located at or after an end of a GNSS measurement time window. The wireless communication node may determine that the wireless communication device has failed to successfully perform the GNSS positioning, if the wireless communication node did not received the message within the one or more resources. The configuration can be configured or indicated via a signaling from the wireless communication node to the wireless communication device. The signaling may comprise at least one of: a system information block signaling, a radio resource control (RRC) signaling, a medium access control control element (MAC CE) signaling, or a downlink control information (DCI) signaling. The one or more resources can be configured by the wireless communication node via at least one of: a system information block signaling, a radio resource control (RRC) signaling, or a medium access control control element (MAC CE) signaling, before or after a GNSS measurement time window.

In some embodiments, the message indicative of successful performance of GNSS positioning may comprise at least one of: a signaling (e.g., dedicated signaling, or RRC/MAC-CE signaling), or an indication (e.g., bit or field value) in the signaling, that is defined to indicate the successful performance of GNSS positioning; a message providing or reporting a GNSS validity duration (e.g., a duration within which GNSS positioning information acquired via GNSS measurement); or an uplink transmission. In some embodiments, the UE may not able to ensure whether the UL transmission is successfully received by the gNB. The UE can only ensure that a UL transmission is performed within the configured time window/timer/resource.

In some embodiments, the wireless communication device may send an indication of a GNSS validity duration to the wireless communication node (e.g., a BS). The indication may comprise at least one of: an indication of a remaining portion of the GNSS validity duration, after an end of a GNSS measurement time window; an indication of a remaining portion of the GNSS validity duration, after a start time of sending a message carrying the indication of the GNSS validity duration; an indication of a remaining portion of the GNSS validity duration, after an end time of sending the message carrying the indication of the GNSS validity duration; an indication of a start time and an end time of the GNSS validity duration; an indication of a first time offset (e.g., a number of slots) relative to a start time or end time of the GNSS measurement time window or a window indicated by the configuration (e.g., transmission restriction, timing restriction), as the start time of the GNSS validity duration; an indication of a second time offset relative to the start time or end time of the GNSS measurement time window or the window indicated by the configuration, as the end time of the GNSS validity duration; or an indication of a length of the GNSS validity duration, wherein the start time of the GNSS validity duration is the end time of the GNSS measurement time window or the window indicated by the configuration. The wireless communication device may send the indication via a radio resource control (RRC) signaling, or a medium access control control element (MAC CE) signaling to the wireless communication node.

In some embodiments, the wireless communication device may send, to the wireless communication node, the indication according to a transmission restriction that comprises at least one of: a specific time window that starts from or after an end of a GNSS measurement time window; a timer duration that starts from or after the end of a GNSS measurement time window; or one or more resources configured to be located at or after the end of a GNSS measurement time window.

In some embodiments, the wireless communication device may send, to the wireless communication node, the indication over resource comprise at least one of: a physical uplink control channel (PUCCH) resource; a physical uplink shared channel (PUSCH) resource corresponding to a configured grant transmission; or an uplink (UL) resource located at or after an end of a GNSS measurement time window. The UE may send a scheduling request (SR). Then, in some examples, the SR it-self may be treated as the message. In some examples, after the reception of SR, the gNB may schedule the following PUSCH transmission for UE to report information, e.g., validity duration. The PUSCH resource may refer to the resource for configured-grant based PUSCH transmission. The configuration of the PUSCH resource can be from RRC. In some examples, the periodicity of the PUSCH resource for configured grant can be determined based on at least one of the validity duration of GNSS, length of measurement gap for GNSS acquisition and window for report the message. Some specific restriction on the resource configuration in time domain. In some examples, the TA for UL transmission can be taken in to account in the configuration of UL resource in time domain. In some examples, once the validity duration is quantized in the pre-defined table or according to the configured threshold by the gNB (e.g., via RRC), the bits to represent the GNSS validity duration can be carried by the PUCCH accordingly.

In some embodiments, a wireless communication node (e.g., a BS) may send a configuration for sending a message indicative of successful performance of global navigation satellite system (GNSS) positioning to a wireless communication device (e.g., a UE). The wireless communication node may receive, from the wireless communication device, the message in response to the successful performance of GNSS positioning, according to the configuration.

In some embodiments, a wireless communication device may send a signaling to a wireless communication node. The signaling may comprise an indication of a global navigation satellite system (GNSS) validity duration. The indication may comprise at least one of: an indication of a remaining portion of the GNSS validity duration, after an end of a GNSS measurement time window; an indication of a remaining portion of the GNSS validity duration, after a start time of sending a message carrying the indication of the GNSS validity duration; an indication of a remaining portion of the GNSS validity duration, after an end time of sending the message carrying the indication of the GNSS validity duration; an indication of a start time and an end time of the GNSS validity duration; an indication of a first time offset relative to a start time or end time of the GNSS measurement time window or a window indicated by the configuration, as the start time of the GNSS validity duration; an indication of a second time offset relative to the start time or end time of the GNSS measurement time window or the window indicated by the configuration, as the end time of the GNSS validity duration; or an indication of a length of the GNSS validity duration, wherein the start time of the GNSS validity duration is the end time of the GNSS measurement time window or the window indicated by the configuration.

In some embodiments, the signaling may comprise at least one of: a radio resource control (RRC) signaling, or a medium access control control element (MAC CE) signaling.

In some embodiments, the wireless communication device may send, to the wireless communication node, the indication according to a transmission restriction that comprises at least one of: a specific time window that starts from or after an end of a GNSS measurement time window; a timer duration that starts from or after the end of a GNSS measurement time window; or one or more resources configured to be located at or after the end of a GNSS measurement time window.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates an example implementation of a non-terrestrial network (NTN), in accordance with some embodiments of the present disclosure;

FIG. 4 illustrates an example global navigation satellite system (GNSS) positioning during RRC_CONNECTED mode, in accordance with some embodiments of the present disclosure;

FIG. 5 illustrates an example waiting time window after global navigation satellite system (GNSS) measurement time window/gap, in accordance with some embodiments of the present disclosure;

FIG. 6 illustrates an example waiting timer after global navigation satellite system (GNSS) measurement time window/gap, in accordance with some embodiments of the present disclosure;

FIG. 7 illustrates an example dedicated resource after global navigation satellite system (GNSS) measurement time window/gap, in accordance with some embodiments of the present disclosure; and

FIG. 8 illustrates a flow diagram of an example method for global navigation satellite system (GNSS) related information indication, in accordance with an embodiment of the present disclosure.

### DETAILED DESCRIPTION

### 1. Mobile Communication Technology and Environment

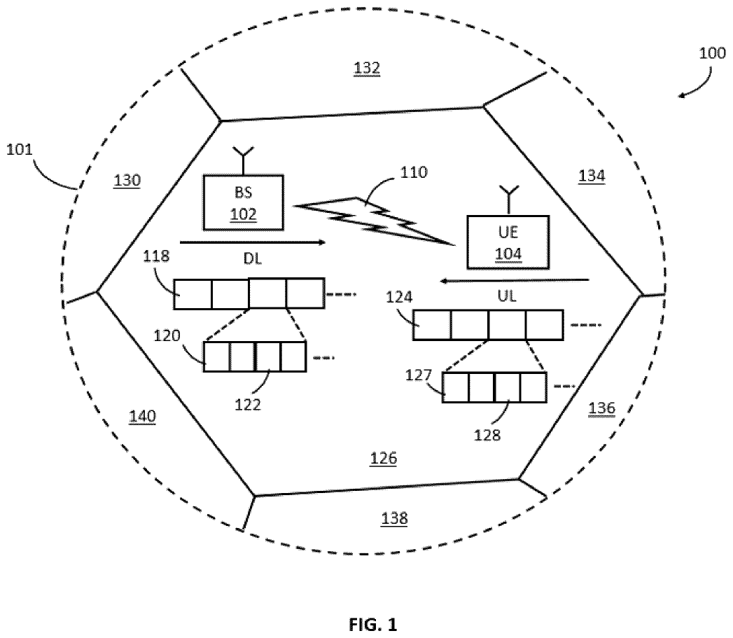

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

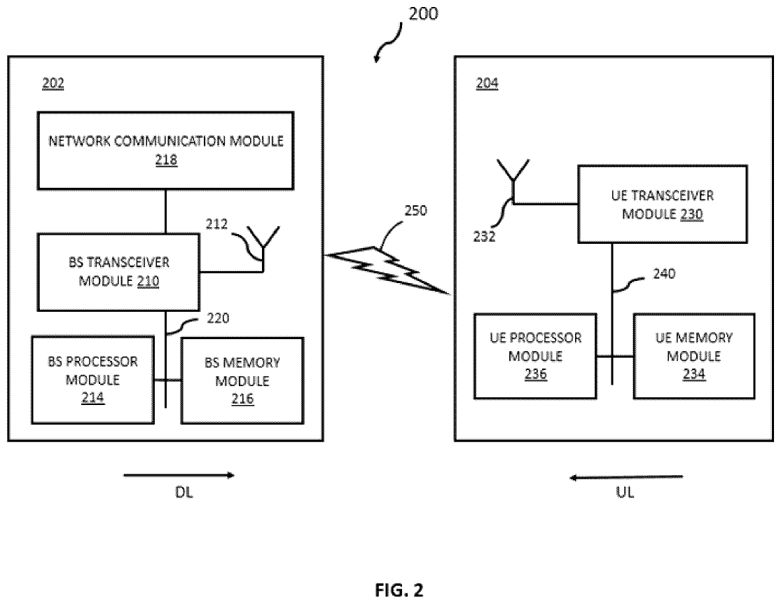

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Global Navigation Satellite System (GNSS) Related Information Indication

In a non-terrestrial network (NTN), due to high altitude and mobility of satellite, a propagation delay may be large and vary fast. To handle the large and varying propagation delay, a UE pre-compensation solution can be applied. A UE may perform autonomous estimation and pre-compensation of timing advance (TA) based on a location of the UE and satellite ephemeris. The location of the UE can be assumed to be obtained through a global navigation satellite system (GNSS) operation. However, in an Internet of things (IoT)-NTN, cellular operation and GNSS positioning may not be simultaneously performed due to limited device capability. Therefore, in a later defined IoT-NTN, a UE may not update GNSS information during cellular operation. Since the GNSS information may be valid only during a period of time, especially when a UE is moving, a validity duration associated with the GNSS information can be defined to illustrate during which time a UL synchronization can be kept without updating GNSS information. The GNSS related information (e.g., whether the GNSS positioning is successful and how long the GNSS information can be valid) can be determined by the UE, which performs the GNSS operation. In order to achieve consensus with network, the UE may report certain GNSS information to a network, which can avoid potential resource waste and interference due to scheduling of UL transmission when UL synchronization is lost. In the present disclosure, a method for global navigation satellite system (GNSS) information report can be performed.

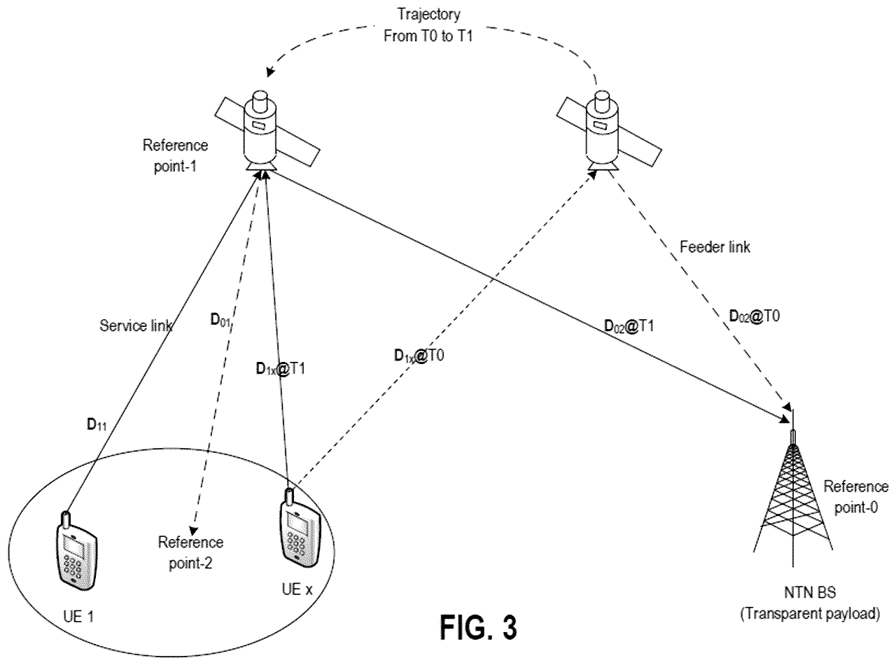

FIG. 3 illustrates an example structure of a transparent NTN, in accordance with some embodiments of the present disclosure. A link between a UE (e.g., a user equipment, the UE 104, the UE 204, a mobile device, a wireless communication device, a terminal, etc.) and a satellite can be a service link. A link between a BS (e.g., a base station, the BS 102, the BS 202, a gNB, an evolved Node B (eNB), a wireless communication node, etc.) and a satellite can be a feeder link and can be common for all UEs within the same cell.

In an IoT-NTN, due to limited UE capability, a UE may not be assumed to perform cellular operation and GNSS operation simultaneously. In a first type of IoT-NTN, a UE may be assumed to perform GNSS measurement only in an IDLE mode. The UE may report the GNSS validity duration in msg5. If the GNSS validity duration is expired, a UL synchronization can be considered/thought lost. The UE may go back to an IDLE mode. In a second type of IoT-NTN, a UE performing GNSS measurement in a RRC_CONNECTED mode can be performed. However, the UE may not detect a DL transmission and may transmit a UL transmission when performing a GNSS measurement.

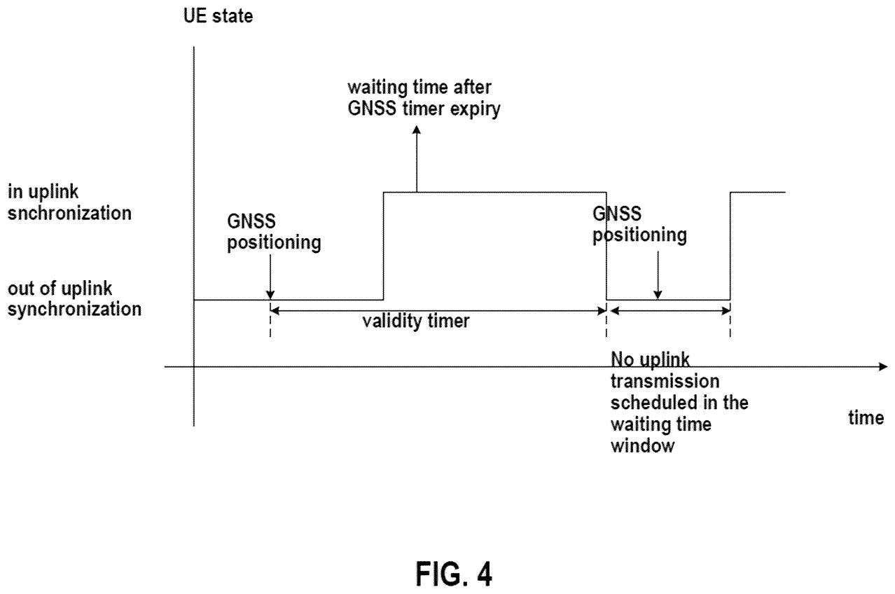

A UE may report a GNSS validity duration and a time window after validity duration expiry to a network. The UE may determine during which time a GNSS positioning is performed. After an initial access, the UE may report GNSS validity duration to the network. When the validity duration is expired, the UE can reacquire GNSS position to maintain UL synchronization within a time window. During the time window, the UE may refrain from performing an uplink transmission, and the network may refrain from scheduling the UE for uplink transmission. After reacquiring the GNSS, a cellular operation can be continued until next expiry and next reacquiring of GNSS, as shown in FIG. 4.

Moreover, other solutions may also enable the UE to perform GNSS positioning during a RRC_CONNECTED mode. For example, the network may configure a GNSS measurement gap before expiry of validity duration. The network may further indicate a start time and a length of a measurement gap through a certain signaling. In anyway, a time window/gap can be utilized when performing GNSS measurement, to avoid simultaneous cellular and GNSS operation.

### Implementation Example 1: Success Indication of GNSS Positioning

If a UE is supported to perform GNSS positioning during a RRC_CONNECTED mode in IoT-NTN, a time window/gap can be defined for GNSS measurement. No cellular operation may be performed during the time window/gap. In order to avoid scheduling of transmission during the time window/gap, the UE and an eNB may achieve consensus on the timing of the time window/gap (e.g., the start and length of time window/gap). Moreover, it is beneficial that the eNB also knows whether the GNSS positioning is successful. By knowing whether GNSS positioning is successful, the eNB can avoid scheduling UL transmissions when UL synchronization is lost due to GNSS positioning failure.

To indicate the success of GNSS positioning, one of following solutions may be considered.

(i) An explicit dedicated signaling can be defined to indicate the success of GNSS positioning. The UE may report a success of GNSS positioning after the time window/gap for GNSS measurement. A bit may be defined to express whether the GNSS positioning is successful. For example, if “1” is reported, the network may consider/think that UE successfully acquired a new GNSS position during the time window/gap. If “0” is reported or the bit is absent, the network may consider/think that the UE failed to acquire a new GNSS position during the time window/gap. The report may be indicated through a media access control control element (MAC CE) or radio resource control (RRC) signaling.

(ii) The success of GNSS positioning can be implicitly indicated by a report of new GNSS validity duration. The UE may report validity duration associated with GNSS information. The GNSS information may indicate during which time the GNSS position can be used for pre-compensation. When a new GNSS validity duration is reported, the report may implicitly indicate that the GNSS positioning is successful.

(iii) The success of GNSS positioning can be implicitly indicated by any successful UL transmission after the time window/gap. A solution for GNSS measurement during RRC_CONNECTED mode can be performed. The time window/gap for GNSS measurement may start after expiry of previous GNSS validity duration. In such case, if the UE failed to acquire new GNSS position, the UL synchronization may be lost and no UL transmission can be expected. Therefore, if a UL transmission is successfully received by the network, it may implicitly indicate that the UE successfully acquired new GNSS position.

No matter which of above solution is applied, the UE may transmit or may report something after the time window/gap for GNSS measurement. With introduction of success indication mechanism, the eNB may avoid scheduling UL or DL transmission after a GNSS measurement time window/gap but before receiving the success indication (e.g., especially when no valid GNSS information exists (e.g., when previous GNSS validity duration expired)).

If the UE failed the GNSS positioning, the UE may not be able to keep UL synchronization (e.g., when the GNSS positioning is performed at the expiry time of previous GNSS validity duration) and no UL transmission can be performed in such case. Hence, the CNB may consider/think that the GNSS positioning is failed if the eNB does not receive the success indication for a long time after the GNSS measurement time window/gap. With this consideration, some restriction can be introduced for the success indication. If a timing for performing a UL transmission or report is based on UE implementation, the success indication from the UE to the eNB can be very late after successful GNSS positioning. If the success indication is too late, the eNB may consider/think that the UE failed the GNSS positioning and released the RRC connection before receiving the success indication. Misalignment can happen between the UE and the eNB. In order to resolve this issue, at least one of following methods may be considered.

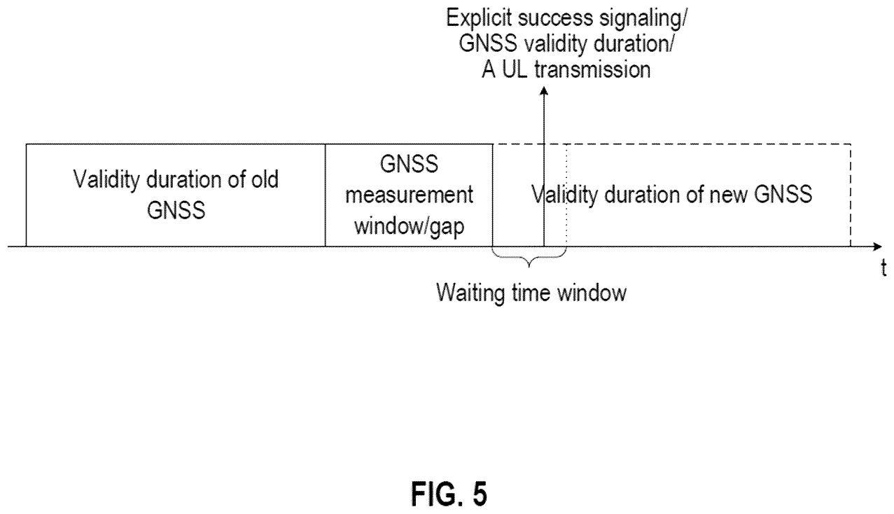

(i) A waiting time window can be defined. The waiting time window may start from an end of GNSS measurement time window/gap (e.g., as shown in FIG. 5). During the waiting time window, the eNB may wait for a UE indication of GNSS positioning success. When the waiting time window ends, the eNB may not wait the success indication and may think/consider that the UE failed the GNSS positioning. The length of this time window may be predefined or configured by network through at least one of a system information block (SIB) broadcast, a radio resource control (RRC) signaling, or a media access control control element (MAC CE) signaling. The UE may indicate the success of GNSS positioning (via the methods introduced above, e.g., explicit signaling, report GNSS validity duration, or any UL transmission) within the time window. If no indication of success is received until the end of the time window, the GNSS positioning can be considered/thought to have failed. FIG. 5 illustrates an example waiting time window after global navigation satellite system (GNSS) measurement time window/gap, in accordance with some embodiments of the present disclosure.

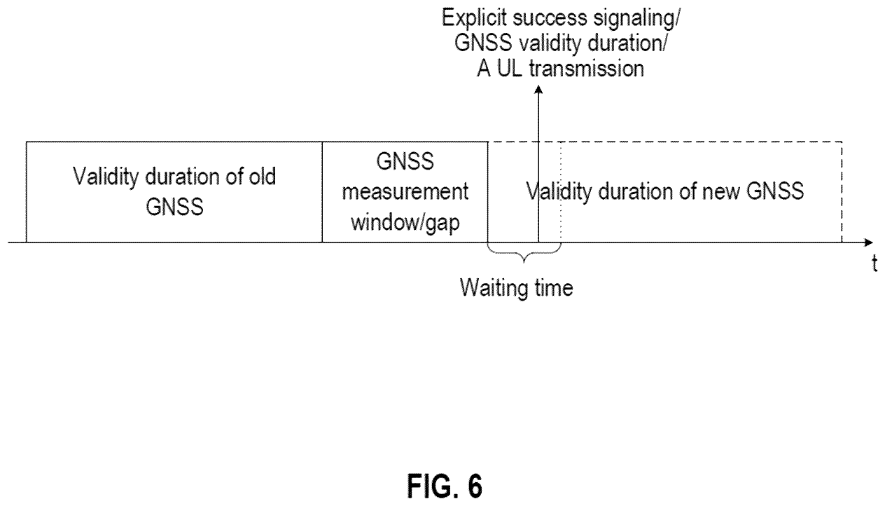

(ii) A waiting timer can be defined. The waiting timer can start from the end of GNSS measurement time window/gap (e.g., as shown in FIG. 6). When the waiting timer is running, the eNB may wait for UE indication of GNSS positioning success. When the waiting timer expires, the NB may not wait the success indication and may consider/think that the UE failed the GNSS positioning. The length of this timer may be predefined or configured by the network through at least one of a SIB broadcast, a RRC signaling, or a MAC CE signaling. The UE may indicate the success of GNSS positioning (via the methods introduced above, e.g., explicit signaling, report GNSS validity duration, or any UL transmission) before expiry of the timer. If no indication of success until the expiry of the timer, the GNSS positioning can be considered/thought failed. FIG. 6 illustrates an example waiting timer after global navigation satellite system (GNSS) measurement time window/gap, in accordance with some embodiments of the present disclosure.

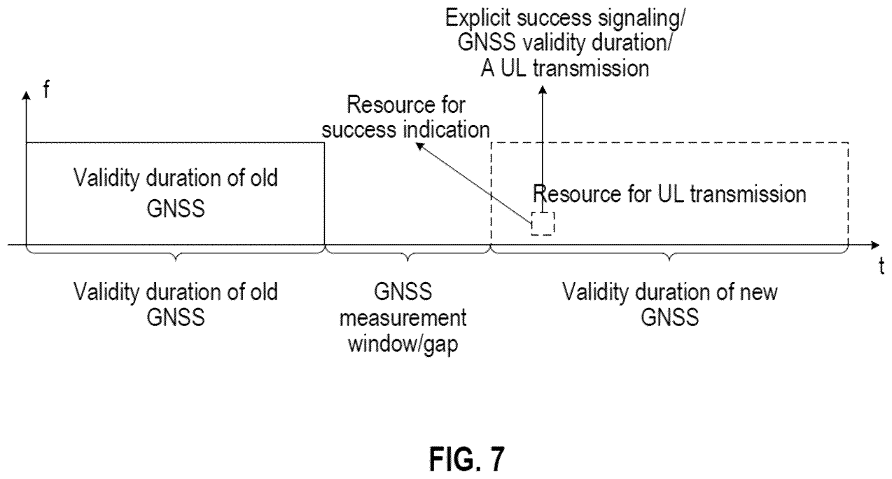

(iii) Dedicated resources can be defined. The dedicated resources for success indication can be configured after the GNSS measurement time window/gap (e.g., as shown in FIG. 7). The resources may be configured by the network through at least one of a SIB broadcast, a RRC signaling, a MAC CE signaling, or a downlink control information (DCI) indication. The UE may indicate the success of GNSS positioning (via the methods introduced above, e.g., explicit signaling, report GNSS validity duration, or any UL transmission) using the configured resources. If no success indication is performed using the configured resources, the GNSS positioning can be considered/thought failed. FIG. 7 illustrates an example dedicated resource after global navigation satellite system (GNSS) measurement time window/gap, in accordance with some embodiments of the present disclosure.

Combination of solutions and restrictions may include at least one of: an explicit signaling+a time window; an explicit signaling+a timer; an explicit signaling+a configured resource; a validity duration+a time window; a validity duration+a timer; a validity duration+a configured resource; any UL transmission+a time window; any UL transmission+a timer; or any UL transmission+a configured resource. Based on above potential solutions and restrictions of success indication, at least one of following examples may be possible.

Example 1: A dedicated signaling can be defined for a UE to report a success of GNSS positioning. The report signaling may be a RRC signaling or a MAC CE signaling. A waiting time window can be defined for the report signaling. The length of waiting time window can be broadcast in SIB or configured through dedicated RRC signaling/MAC CE signaling by the eNB. The start of waiting time window can be the end of GNSS measurement time window/gap. If the UE successfully acquires new GNSS position during a GNSS measurement time window/gap, the UE may report the success of GNSS positioning during the waiting time window after GNSS measurement time window/gap. Otherwise, the UE may not report the success signaling, or may report a failure signaling. If the CNB receives the success signaling within the waiting time window, the GNSS positioning within the corresponding GNSS measurement time window/gap can be considered/thought successful by the eNB. Otherwise, if the CNB receives a failure signaling within the waiting time window or does not receive success signaling until the end of waiting time window, the GNSS positioning within the corresponding GNSS measurement time window/gap can be considered/thought failed by the eNB. The CNB may release the RRC connection with the UE, or may trigger the UE to re-access the network.

Example 2: A dedicated signaling can be defined for the UE to report the success of GNSS positioning similar as example 1. A waiting timer can be defined for the report a signaling. The length of waiting timer can be broadcasted in a SIB or configured through a dedicated RRC signaling/MAC CE signaling by the eNB. The start of waiting timer can be the end of GNSS measurement time window/gap. If the UE successfully acquires new GNSS position during a GNSS measurement time window/gap, the UE may report the success of GNSS positioning after GNSS measurement time window/gap but before expiry of waiting timer. Otherwise, the UE may not report the success signaling, or may report a failure signaling. If the eNB receives the success signaling before expiry of waiting timer, the GNSS positioning within the corresponding GNSS measurement time window/gap can be considered/thought successful by the eNB. Otherwise, if the eNB receives a failure signaling before expiry of waiting timer or does not receive success signaling until the expiry of waiting timer, the GNSS positioning within the corresponding GNSS measurement time window/gap can be considered/thought failed by the eNB. The eNB may release the RRC connection with the UE, or may trigger the UE to re-access the network.

Example 3: A dedicated signaling can be defined for the UE to report the success of GNSS positioning similar as example 1. The eNB may configure time and/or frequency resources to the UE for the report of success signaling. The configuration of time resources may be an indication of start SFN and slot number, a start time offset with respect to end/start of GNSS measurement time window/gap, a start time offset with respect to receiving time of configuration information, or a length of time resources. The configuration of frequency resources may be an indication of a start offset of physical resource block (PRB) (e.g., with respect to point A), a start PRB index, or a width of frequency resources.

At least one of following configuration methods may be considered.

(a) The eNB may directly configure the time and/or frequency resources using a dedicated RRC signaling or a MAC CE signaling before the GNSS measurement time window/gap. The UE may apply the configured resources for reporting after the GNSS measurement time window/gap. The report delay can be minimized.

(b) The eNB may directly configure the time and/or frequency resources using dedicated RRC signaling or MAC CE signaling or DCI signaling after the GNSS measurement time window/gap. The UE may report using the configured resources. There may be no need to consider a scheduling delay.

(c) The eNB may use a SIB to broadcast a time offset and a time domain length to indicate the time resources for success report signaling after each GNSS measurement time window/gap. The CNB may use a SIB to broadcast frequency resources common for all success report signaling after each GNSS measurement time window/gap. The UE may report using the configured resources. A signaling overhead can be save due to application of broadcast.

If the UE successfully acquires new GNSS position during a GNSS measurement time window/gap, the UE may report the success of GNSS positioning after GNSS measurement time window/gap using the configured resource. Otherwise, the UE may not report the success signaling, or report a failure signaling. If the eNB receives the success signaling in the configured resource, the GNSS positioning within the corresponding GNSS measurement time window/gap can be considered/thought successful by the CNB. Otherwise, if eNB receives a failure signaling in the configured resource or does not receive success signaling in the configured resource, the GNSS positioning within the corresponding GNSS measurement time window/gap can be considered/thought failed by the eNB. The eNB may release the RRC connection with the UE, or may trigger the UE to re-access the network.

Example 4: The UE may report a GNSS validity duration after successful GNSS positioning. The report signaling may be a RRC signaling or a MAC CE signaling. A waiting time window can be defined for the report signaling. The length of waiting time window can be broadcast in a SIB or configured through a dedicated RRC signaling/MAC CE signaling by the eNB. The start of waiting time window can be the end of GNSS measurement time window/gap. If the UE successfully acquires new GNSS position during a GNSS measurement time window/gap, the UE may report the GNSS validity duration during the waiting time window after GNSS measurement time window/gap. Otherwise, the UE may not report the GNSS validity duration or may report the remaining validity duration of old GNSS information. If the eNB receives new GNSS validity duration within the waiting time window, the GNSS positioning within the corresponding GNSS measurement time window/gap can be considered/thought successful by the eNB. Otherwise, if the CNB does not receive a GNSS validity duration until the end of waiting time window or receives the remaining validity duration of old GNSS information within the waiting time window, the GNSS positioning within the corresponding GNSS measurement time window/gap can be considered/thought failed by the eNB. The CNB may release the RRC connection with the UE, or trigger the UE to re-access the network.

Example 5: The UE may report a GNSS validity duration after successful GNSS positioning similar as example 4. A waiting timer can be defined for the report signaling. The length of waiting timer can be broadcasted in a SIB or configured through a dedicated RRC signaling/MAC CE signaling by the eNB. The start of waiting timer can be the end of GNSS measurement time window/gap. If UE successfully acquires new GNSS position during a GNSS measurement time window/gap, the UE may report the GNSS validity duration after GNSS measurement time window/gap but before expiry of waiting timer. Otherwise, the UE may not report the GNSS validity duration, or may report the remaining validity duration of old GNSS information. If the eNB receives new GNSS validity duration before expiry of waiting timer, the GNSS positioning within the corresponding GNSS measurement time window/gap can be considered/thought successful by the eNB. Otherwise, if the eNB does not receive a GNSS validity duration until expiry of waiting timer or receives the remaining validity duration of old GNSS information before expiry of waiting timer, the GNSS positioning within the corresponding GNSS measurement time window/gap can be considered/thought failed by the eNB. The eNB may release the RRC connection with the UE, or trigger the UE to re-access the network.

Example 6: The UE may report GNSS validity duration after successful GNSS positioning similar as example 4. The eNB may configure the time and/or frequency resources to UE for the report of GNSS validity duration. The configuration of time resources may be an indication of a start SFN and a slot number, a start time offset with respect to end/start of GNSS measurement time window/gap, a start time offset with respect to receiving time of configuration information, or a length of time resources. The configuration of frequency resources may be an indication of a start offset of PRB (e.g., with respect to point A), a start PRB index, or a width of frequency resources.

At least one of following configuration methods may be considered.

(a) The eNB may directly configure the time and/or frequency resources using a dedicated RRC signaling or a MAC CE signaling before the GNSS measurement time window/gap. The UE may apply the configured resources for reporting of GNSS validity duration after the GNSS measurement time window/gap. A report delay can be minimized.

(b) The eNB may directly configure the time and/or frequency resources using a dedicated RRC signaling, a MAC CE signaling, or a DCI signaling after the GNSS measurement time window/gap. The UE may report a GNSS validity duration using the configured resources. There may be no need to consider scheduling delay.

(c) The eNB may use a SIB to broadcast a time offset and a time domain length to indicate the time resources for success report signaling after each GNSS measurement time window/gap. The eNB may use SIB to broadcast frequency resources common for all success report signaling after each GNSS measurement time window/gap. The UE may report GNSS validity duration using the configured resources. A signaling overhead can be save due to the application of broadcast.

If the UE successfully acquires new GNSS position during a GNSS measurement time window/gap, the UE may report GNSS validity duration after GNSS measurement time window/gap using the configured resource. Otherwise, the UE may not report the GNSS validity duration, or may report the remaining validity duration of old GNSS information. If the eNB receives new GNSS validity duration in the configured resource, the GNSS positioning within the corresponding GNSS measurement time window/gap can be considered/thought successful by the eNB. Otherwise, if the eNB does not receive new GNSS validity duration in the configured resource or may receive the remaining validity duration of old GNSS information in the configured resource, the GNSS positioning within the corresponding GNSS measurement time window/gap can be considered/thought failed by the eNB. The eNB may release the RRC connection with the UE, or may trigger the UE to re-access the network.

Example 7: The UE may perform a UL transmission after successful GNSS positioning for implicit indication of success. The UL transmission can be any type of UL transmission (e.g., a scheduling request (SR), a physical random access channel (PRACH), a physical uplink shared channel (PUSCH), or a physical uplink control channel (PUCCH)). A waiting time window can be defined for such UL transmission. The length of waiting time window can be broadcasted in a SIB or configured through a dedicated RRC signaling/MAC CE signaling by the eNB. The start of waiting time window can be the end of GNSS measurement time window/gap. If UE successfully acquires new GNSS position during a GNSS measurement time window/gap, the UE may perform at least one UL transmission during the waiting time window after GNSS measurement time window/gap. Otherwise, the UE may not perform any UL transmission. If the eNB receives a UL transmission within the waiting time window, the GNSS positioning within the corresponding GNSS measurement time window/gap can be considered/thought successful by the eNB. Otherwise, if the eNB does not receive any UL transmission until the end of waiting time window, the GNSS positioning within the corresponding GNSS measurement time window/gap can be considered/thought failed by the eNB. The eNB may release the RRC connection with the UE, or may trigger the UE to re-access the network.

Example 8: The UE may perform a UL transmission after successful GNSS positioning for implicit indication of success. The UL transmission can be any type of UL transmission (e.g., a SR, a PRACH, a PUSCH, or a PUCCH). A waiting timer can be defined for such UL transmission. The length of waiting timer can be broadcasted in a SIB or configured through dedicated RRC signaling/MAC CE signaling by the eNB. The start of waiting timer can be the end of GNSS measurement time window/gap. If the UE successfully acquires new GNSS position during a GNSS measurement time window/gap, the UE may perform at least one UL transmission after GNSS measurement time window/gap but before expiry of waiting timer. Otherwise, the UE may not perform any UL transmission. If the eNB receives a UL transmission before expiry of waiting timer, the GNSS positioning within the corresponding GNSS measurement time window/gap can be considered/thought successful by the eNB. Otherwise, if the eNB does not receive any UL transmission until expiry of waiting timer or receives the remaining validity duration of old GNSS information before expiry of waiting timer, the GNSS positioning within the corresponding GNSS measurement time window/gap can be considered/thought failed by the eNB. The CNB may release the RRC connection with the UE, or trigger the UE to re-access the network.

Example 9: The UE may perform a UL transmission after successful GNSS positioning for implicit indication of success. The UL transmission can be any type of UL transmission (e.g., a SR, a PRACH, a PUSCH, or a PUCCH). The CNB may configure time and/or frequency resources to the UE for such UL transmission. The configuration of time resources may be an indication of a start SFN and a slot number, a start time offset with respect to end/start of GNSS measurement time window/gap, a start time offset with respect to receiving time of configuration information, or a length of time resources. The configuration of frequency resources may be an indication of a start offset of PRB (e.g., with respect to point A), a start PRB index, or a width of frequency resources. The configured resource may be a random access channel occasion (RO), a PRACH preamble resource, a PUCCH resource, or a PUSCH resource.

At least one of following configuration methods may be considered.

(a) The eNB may directly configure time and/or frequency resources using a dedicated RRC signaling or a MAC CE signaling before the GNSS measurement time window/gap. The UE may apply the configured resources for a UL transmission after the GNSS measurement time window/gap. A report delay can be minimized.

(b) The eNB may directly configure the time and/or frequency resources using a dedicated RRC signaling, a MAC CE signaling, or a DCI signaling after the GNSS measurement time window/gap. The UE may perform a UL transmission using the configured resources. There can be no need to consider scheduling delay.

(c) The eNB may use SIB to broadcast a time offset and a time domain length to indicate the time resources for success report signaling after each GNSS measurement time window/gap. The eNB may use SIB to broadcast frequency resources common for all success report signaling after each GNSS measurement time window/gap. The UE may perform a UL transmission using the configured resources. A signaling overhead can be save due to application of broadcast.

If the UE successfully acquires new GNSS position during a GNSS measurement time window/gap, the UE may perform at least one UL transmission after GNSS measurement time window/gap using the configured resource. Otherwise, the UE may not perform any UL transmission. If the eNB receives a UL transmission in the configured resource, the GNSS positioning within the corresponding GNSS measurement time window/gap can be considered/thought successful by the eNB. Otherwise, if the eNB does not receive any UL transmission in the configured resource, the GNSS positioning within the corresponding GNSS measurement time window/gap can be considered/thought failed by the eNB. The eNB may release the RRC connection with the UE, or may trigger the UE to re-access the network.

### Implementation Example 2: GNSS Validity Duration Report after GNSS Measurement Time Window/Gap

A solution to enable a UE to obtain GNSS information in a RRC_CONNECTED mode can be performed. When a GNSS validity duration expires, a GNSS measurement time window/gap may start for the UE to reacquire GNSS position. After reacquiring GNSS position, the UE can keep UL synchronization and can continue cellular operation. Since the UE and the eNB may achieve consensus on the validity duration of each GNSS information, a UE report of GNSS validity duration can be supported. A solution for GNSS validity duration report may include at least one of: (a) a time length between a starting of the validity timer and a random access transmission by the wireless device; (b) a time length between the starting of the validity timer and transmission of the information; (c) a time length of a rest time of the validity timer after the random access transmission; (d) a time length of the rest time of the validity timer after transmitting the information; (c) a time stamp of a starting time of the validity timer; (f) a time stamp of an expiry time of the validity timer; or (g) a time length of the validity timer. From above solutions, it can be observed that the potential solutions are mainly for initial access. In this disclosure, a GNSS validity duration report after a GNSS measurement time window/gap can be focused and at least one of following potential solutions can be considered: (a) the UE reports the remaining validity duration after the end of GNSS measurement time window/gap; (b) the UE reports the remaining validity duration after the report signaling; (c) the UE reports the start time and length of GNSS validity duration; (d) the UE reports the length of GNSS validity duration; or (c) the UE reports the length of GNSS validity duration. In solution (b), the remaining validity duration may be counted from the start time of transmitting the report signaling, or from the end time of transmitting the report signaling. The start time of transmitting the report signaling may be the start of the first subframe of the message carrying the report signaling. The end time of transmitting the report signaling may be the start of the last subframe of the message carrying the report signaling. The end time of transmitting the report signaling may be the end of the last subframe of the message carrying the report signaling. In solution (c), the start time may be reported using a time offset with respect to end of GNSS measurement time window/gap used for the GNSS positioning, or using a time offset with respect to end of waiting time window/expiring time of waiting timer (for success indication) after GNSS measurement time window/gap used for this GNSS positioning, or using the SFN and the slot number. When a time offset used for start time indication, it may be expressed by number of slots. In solution (d), the start time of GNSS validity duration can be the end of GNSS measurement time window/gap. In solution (c), the start time of GNSS validity duration can be the end of waiting time window/expiring time of waiting timer (for success indication) after GNSS measurement time window/gap.

When UE's mobility is stable, the validity duration of new GNSS may be same as the old one. In this case, additional enhancement may be adopted to save signaling overhead. For example, no report of GNSS validity duration may indicate that the validity duration of new GNSS is unchanged or same as the previous one. The report may be triggered when the difference between new GNSS validity duration and previous GNSS validity duration is equal or larger than a threshold. The threshold may be predefined, determined by UE, or configured by network. This could be applied when network thinks/determines GNSS positioning is successful (e.g., a message indicative of successful GNSS positioning is transmitted from UE to BS using a method other than reporting new GNSS validity duration, such as an explicit success indication or any UL transmission successfully received by the BS as mentioned previously, or network always assumes the GNSS positioning is successful). For another example, an additional signaling can be defined for GNSS validity duration report. The additional signaling may be a one bit signaling. When “1” is reported, it may mean/indicate that the new GNSS validity duration is unchanged or same as the previous one. The signaling of reporting detailed validity duration mentioned in previous paragraph may not be transmitted. When “0” is reported, the signaling of reporting detailed validity duration mentioned in previous paragraph may be transmitted. Or vice versa, when “0” is reported, it may mean/indicate the new GNSS validity duration is unchanged or same as the previous one. The signaling of reporting detailed validity duration mentioned in previous paragraph may not be transmitted. When “1” is reported, the signaling of reporting detailed validity duration mentioned in previous paragraph may be transmitted.

The UE may report above information via a RRC signaling or MAC CE signaling. The report may follow restrictions mentioned in implementation example 1 (e.g., reported within certain time window/timer/resources after a GNSS measurement time window/gap).

It should be understood that one or more features from the above implementation examples are not exclusive to the specific implementation examples, but can be combined in any manner (e.g., in any priority and/or order, concurrently or otherwise).

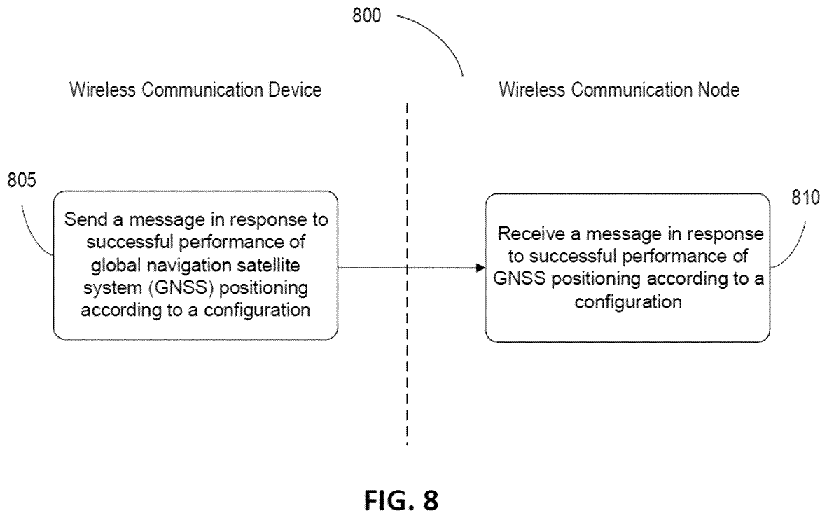

FIG. 8 illustrates a flow diagram of a method 800 for global navigation satellite system (GNSS) related information indication. The method 800 may be implemented using any one or more of the components and devices detailed herein in conjunction with FIGS. 1-2. In overview, the method 800 may be performed by a wireless communication device (e.g., a UE), in some embodiments. Additional, fewer, or different operations may be performed in the method 800 depending on the embodiment. At least one aspect of the operations is directed to a system, method, apparatus, or a computer-readable medium.

A wireless communication device (e.g., a UE) may send a message in response to successful performance of global navigation satellite system (GNSS) positioning to a wireless communication node (e.g., a BS) according to a configuration (e.g., time window, timer length, resource(s), restriction). The configuration can be from the wireless communication node, and can be a configuration for sending one or more messages indicative of successful performance of GNSS positioning. The configuration may comprise information on at least one of: a specific time window; a timer; or one or more resources. The configuration can be done via RRC signaling or selected resource by MAC CE or indicated by scheduling via DCI. The resource is used to carrying the message.

In some embodiments, the resource may comprise at least one of: a preamble index; a RO configuration; a PUCCH resource; a PUSCH resource corresponding to configured grant transmission; or a UL resource located at or after an end of a GNSS measurement time window. The UE may send the preamble with dedicated index (or mask) or over dedicated RO. In some examples, the preamble it-self may be treated as the message. The UE may send a scheduling request (SR). In some examples, the SR it-self may be treated as the message. In some examples, after the reception of SR, the gNB may schedule the following PUSCH transmission for UE to report information, e.g., validity duration. The PUSCH resource may refer to the resource for configured-grant based PUSCH transmission. The configuration of this resource can be from RRC. In some examples, the periodicity of the PUSCH resource for configured grant can be determined based on at least one of the validity duration of GNSS, length of measurement gap for GNSS acquisition and window for report the message. The UL resource can be some specific restrictions on the resource configuration in time domain. In some examples, the TA for UL transmission can be taken in to account in the configuration of UL resource in time domain.

In some embodiments, the specific time window may start from or after an end of a GNSS measurement time window (e.g., a gap). A length of the specific time window can be indicated in the configuration. The wireless communication node may determine that the wireless communication device has failed to successfully perform the GNSS positioning, if the wireless communication node has not received the message by end of the specific time window. When the specific time window starts after an end of a GNSS measurement time window, at least one of: a start time of the specific time window is indicated in the configuration; or the start of the specific time window is after a time offset with respect to the end of the GNSS measurement time window, wherein the time offset is indicated in the configuration or is predefined.

In some embodiments, the timer may start from or after an end of a GNSS measurement time window. A length of the timer's duration can be configured by network. The wireless communication node may determine that the wireless communication device has failed to successfully perform the GNSS positioning, if the wireless communication node has not received the message by expiration of the timer. When the timer starts after an end of a GNSS measurement time window, at least one of: a start time of the timer is indicated in the configuration; or the start of the timer is after a time offset with respect to the end of the GNSS measurement time window, wherein the time offset is indicated in the configuration or is predefined.

In some embodiments, the one or more resources can be configured to be located at or after an end of a GNSS measurement time window. The wireless communication node may determine that the wireless communication device has failed to successfully perform the GNSS positioning, if the wireless communication node did not received the message within the one or more resources. The configuration can be configured or indicated via a signaling from the wireless communication node to the wireless communication device. The signaling may comprise at least one of: a system information block signaling, a radio resource control (RRC) signaling, a medium access control control element (MAC CE) signaling, or a downlink control information (DCI) signaling. The one or more resources can be configured by the wireless communication node via at least one of: a system information block signaling, a radio resource control (RRC) signaling, or a medium access control control element (MAC CE) signaling, before or after a GNSS measurement time window.

In some embodiments, the message indicative of successful performance of GNSS positioning may comprise at least one of: a signaling (e.g., dedicated signaling, or RRC/MAC-CE signaling), or an indication (e.g., bit or field value) in the signaling, that is defined to indicate the successful performance of GNSS positioning; a message providing or reporting a GNSS validity duration (e.g., a duration within which GNSS positioning information acquired via GNSS measurement); or an uplink transmission. In some embodiments, the UE may not able to ensure whether the UL transmission is successfully received by the gNB. The UE can only ensure that a UL transmission is performed within the configured time window/timer/resource.

In some embodiments, the wireless communication device may send an indication of a GNSS validity duration to the wireless communication node (e.g., a BS). The indication may comprise at least one of: an indication of a remaining portion of the GNSS validity duration, after an end of a GNSS measurement time window; an indication of a remaining portion of the GNSS validity duration, after a start time of sending a message carrying the indication of the GNSS validity duration; an indication of a remaining portion of the GNSS validity duration, after an end time of sending the message carrying the indication of the GNSS validity duration; an indication of a start time and an end time of the GNSS validity duration; an indication of a first time offset (e.g., a number of slots) relative to a start time or end time of the GNSS measurement time window or a window indicated by the configuration (e.g., transmission restriction, timing restriction), as the start time of the GNSS validity duration; an indication of a second time offset relative to the start time or end time of the GNSS measurement time window or the window indicated by the configuration, as the end time of the GNSS validity duration; or an indication of a length of the GNSS validity duration, wherein the start time of the GNSS validity duration is the end time of the GNSS measurement time window or the window indicated by the configuration. The wireless communication device may send the indication via a radio resource control (RRC) signaling, or a medium access control control element (MAC CE) signaling to the wireless communication node.

In some embodiments, the wireless communication device may send, to the wireless communication node, the indication according to a transmission restriction that comprises at least one of: a specific time window that starts from or after an end of a GNSS measurement time window; a timer duration that starts from or after the end of a GNSS measurement time window; or one or more resources configured to be located at or after the end of a GNSS measurement time window.

In some embodiments, the wireless communication device may send, to the wireless communication node, the indication over resource comprise at least one of a PUCCH resource; a PUSCH resource corresponding to configured grant transmission; or a UL resource located at or after an end of a GNSS measurement time window. The UE may send a scheduling request (SR). Then, in some examples, the SR it-self may be treated as the message. In some examples, after the reception of SR, the gNB may schedule the following PUSCH transmission for UE to report information, e.g., validity duration. The PUSCH resource may refer to the resource for configured-grant based PUSCH transmission. The configuration of the PUSCH resource can be from RRC. In some examples, the periodicity of the PUSCH resource for configured grant can be determined based on at least one of the validity duration of GNSS, length of measurement gap for GNSS acquisition and window for report the message. Some specific restriction on the resource configuration in time domain. In some examples, the TA for UL transmission can be taken in to account in the configuration of UL resource in time domain. In some examples, once the validity duration is quantized in the pre-defined table or according to the configured threshold by gNB (e.g., via RRC), the bits to represent the GNSS validity duration can be carried by the PUCCH accordingly.

In some embodiments, a wireless communication node (e.g., a BS) may send a configuration for sending a message indicative of successful performance of global navigation satellite system (GNSS) positioning to a wireless communication device (e.g., a UE). The wireless communication node may receive, from the wireless communication device, the message in response to the successful performance of GNSS positioning, according to the configuration.

In some embodiments, a wireless communication device may send a signaling to a wireless communication node. The signaling may comprise an indication of a global navigation satellite system (GNSS) validity duration. The indication may comprise at least one of: an indication of a remaining portion of the GNSS validity duration, after an end of a GNSS measurement time window; an indication of a remaining portion of the GNSS validity duration, after a start time of sending a message carrying the indication of the GNSS validity duration; an indication of a remaining portion of the GNSS validity duration, after an end time of sending the message carrying the indication of the GNSS validity duration; an indication of a start time and an end time of the GNSS validity duration; an indication of a first time offset relative to a start time or end time of the GNSS measurement time window or a window indicated by the configuration, as the start time of the GNSS validity duration; an indication of a second time offset relative to the start time or end time of the GNSS measurement time window or the window indicated by the configuration, as the end time of the GNSS validity duration; or an indication of a length of the GNSS validity duration, wherein the start time of the GNSS validity duration is the end time of the GNSS measurement time window or the window indicated by the configuration.

In some embodiments, the signaling may comprise at least one of: a radio resource control (RRC) signaling, or a medium access control control element (MAC CE) signaling.

In some embodiments, the wireless communication device may send, to the wireless communication node, the indication according to a transmission restriction that comprises at least one of: a specific time window that starts from or after an end of a GNSS measurement time window; a timer duration that starts from or after the end of a GNSS measurement time window; or one or more resources configured to be located at or after the end of a GNSS measurement time window.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method comprising:
sending, by a wireless communication device to a wireless communication node according to a configuration, a message in response to successful performance of global navigation satellite system (GNSS) positioning,
wherein the configuration is from the wireless communication node, and is a configuration for sending one or more messages indicative of successful performance of GNSS positioning.

2. The method of claim 1, wherein the configuration comprises information on at least one of:
a specific time window;
a timer; or
one or more resources.

3. The method of claim 2, wherein the resource comprises at least one of:
a preamble index;
a random access channel (RACH) occasion (RO) configuration;
a physical uplink control channel (PUCCH) resource;
a physical uplink shared channel (PUSCH) resource corresponding to a configured grant transmission; or
an uplink (UL) resource located at or after an end of a GNSS measurement time window.

4. The method of claim 2, wherein at least one of:
the specific time window starts from or after an end of a GNSS measurement time window;
a length of the specific time window is indicated in the configuration; or
the wireless communication node determines that the wireless communication device has failed to successfully perform the GNSS positioning, if the wireless communication node has not received the message by end of the specific time window.

5. The method of claim 4, wherein when the specific time window starts after an end of a GNSS measurement time window, at least one of:
a start time of the specific time window is indicated in the configuration; or
the start of the specific time window is after a time offset with respect to the end of the GNSS measurement time window, wherein the time offset is indicated in the configuration or is predefined.

6. The method of claim 2, wherein at least one of:
the timer starts from or after an end of a GNSS measurement time window;
a length of the timer's duration is configured by network; or
the wireless communication node determines that the wireless communication device has failed to successfully perform the GNSS positioning, if the wireless communication node has not received the message by expiration of the timer.

7. The method of claim 6, wherein when the timer starts after an end of a GNSS measurement time window, at least one of:
a start time of the timer is indicated in the configuration; or
the start of the timer is after a time offset with respect to the end of the GNSS measurement time window, wherein the time offset is indicated in the configuration or is predefined.

8. The method of claim 2, wherein the wireless communication node determines that the wireless communication device has failed to successfully perform the GNSS positioning, if the wireless communication node did not received the message within the one or more resources.

9. The method of claim 1, wherein the configuration is configured or indicated via a signaling from the wireless communication node to the wireless communication device.

10. The method of claim 9, wherein the signaling comprises at least one of: a system information block signaling, a radio resource control (RRC) signaling, a medium access control control element (MAC CE) signaling, or a downlink control information (DCI) signaling.

11. The method of claim 8, wherein the one or more resources are configured by the wireless communication node via at least one of: a system information block signaling, a radio resource control (RRC) signaling, or a medium access control control element (MAC CE) signaling, before or after a GNSS measurement time window.

12. The method of claim 1, wherein the message indicative of successful performance of GNSS positioning comprises at least one of:
a signaling, or an indication in the signaling, that is defined to indicate the successful performance of GNSS positioning;
a message providing or reporting a GNSS validity duration; or
an uplink transmission.

13. The method of claim 1, comprising:
sending, by the wireless communication device to the wireless communication node, an indication of a GNSS validity duration, the indication comprising at least one of:
an indication of a remaining portion of the GNSS validity duration, after an end of a GNSS measurement time window;
an indication of a remaining portion of the GNSS validity duration, after a start time of sending a message carrying the indication of the GNSS validity duration;
an indication of a remaining portion of the GNSS validity duration, after an end time of sending the message carrying the indication of the GNSS validity duration;
an indication of a start time and an end time of the GNSS validity duration;
an indication of a first time offset relative to a start time or end time of the GNSS measurement time window or a window indicated by the configuration, as the start time of the GNSS validity duration;
an indication of a second time offset relative to the start time or end time of the GNSS measurement time window or the window indicated by the configuration, as the end time of the GNSS validity duration; or
an indication of a length of the GNSS validity duration, wherein the start time of the GNSS validity duration is the end time of the GNSS measurement time window or the window indicated by the configuration.

14. The method of claim 13, comprising:
sending, by the wireless communication device to the wireless communication node, the indication via a radio resource control (RRC) signaling, or a medium access control control element (MAC CE) signaling.

15. The method of claim 13, comprising:
sending, by the wireless communication device to the wireless communication node, the indication according to a transmission restriction that comprises at least one of:
a specific time window that starts from or after an end of a GNSS measurement time window; or
a timer duration that starts from or after the end of a GNSS measurement time window.

16. The method of claim 13, comprising:
sending, by the wireless communication device to the wireless communication node, the indication over a resource that comprises at least one of:
a physical uplink control channel (PUCCH) resource;
a physical uplink shared channel (PUSCH) resource corresponding to a configured grant transmission; or
an uplink (UL) resource located at or after an end of a GNSS measurement time window.

17. A method comprising:
receiving, by a wireless communication node from a wireless communication device according to a configuration, a message in response to successful performance of global navigation satellite system (GNSS) positioning,
wherein the configuration is from the wireless communication node, and is a configuration for sending one or more messages indicative of successful performance of GNSS positioning.

18. A wireless communication node comprising:
at least one processor configured to:
receive, via a receiver from a wireless communication device according to a configuration, a message in response to successful performance of global navigation satellite system (GNSS) positioning,
wherein the configuration is from the wireless communication node, and is a configuration for sending one or more messages indicative of successful performance of GNSS positioning.

19. A wireless communication device, comprising:
at least one processor configured to:
send, via a transmitter to a wireless communication node according to a configuration, a message in response to successful performance of global navigation satellite system (GNSS) positioning,
wherein the configuration is from the wireless communication node, and is a configuration for sending one or more messages indicative of successful performance of GNSS positioning.

20. The wireless communication device of claim 19, wherein the configuration comprises information on at least one of:
a specific time window;
a timer; or
one or more resources.
